(19) United States
(12) Patent Application Publication
(10) Pub. No.: US 2012/0224929 A1
(43) Pub. Date: Sep. 6, 2012

(54) CYLINDRICAL CUTTER

(76) Inventor: James R. Anderson, Menominee, MI (US)

(21) Appl. No.: 13/037,518

(22) Filed: Mar. 1, 2011

(51) Int. Cl. B23B 51/04

(52) U.S. Cl. 408/204

(57) ABSTRACT

A cylindrical cutter comprises a base, a generally cylindrical wall, and at least one cutting tooth formed at least partially in the cylindrical wall. The cylindrical wall includes a rim. The cutting tooth has a tapered portion extending beyond the rim. The tapered portion includes a root and a free end. The root of the tapered portion is joined to the cylindrical wall at the rim and has a thickness equal to the cylindrical wall thickness. The tapered portion has an overall taper angle from the free end to the root of at least 3°.

### BACKGROUND

The present invention relates to a cylindrical cutter, adapted for use on a rotary power tool such as a drill to cut holes.

### SUMMARY

The invention provides a cylindrical cutter comprising: a base having an axis of rotation about which the cutter is rotatable; a generally cylindrical wall extending from said base surface in a first direction parallel to the axis of rotation, said cylindrical wall having a cylindrical wall thickness, said cylindrical wall defining a rim; and at least one cutting tooth formed at least partially in the cylindrical wall and having a tapered portion extending in the first direction beyond the rim, the tapered portion including a root and a free end; wherein the root of the tapered portion is joined to the cylindrical wall at the rim and has a thickness equal to the cylindrical wall thickness; where the tapered portion has an overall taper angle from the free end to the root of at least 3°.

In some embodiments, the tapered portion defines an outer surface facing radially away from the axis of rotation and an inner surface facing radially toward the axis of rotation, and wherein at least one of the outer surface and inner surface tapers from the free end to the root at a rate of at least 3°. In some embodiments, the tapered portion defines an outer surface facing radially away from the axis of rotation and an inner surface facing radially toward the axis of rotation, and wherein at least one of the outer surface and inner surface tapers from the free end to the root at a rate of at least 6°.

In some embodiments, the tapered portion defines an outer surface facing radially away from the axis of rotation and an inner surface facing radially toward the axis of rotation, and wherein both the outer surface and the inner surface taper from the free end to the root at a rate of at least 3° each. In some embodiments, the tapered portion defines an outer surface facing radially away from the axis of rotation and an inner surface facing radially toward the axis of rotation, and wherein both the outer surface and the inner surface taper from the free end to the root at a rate of at least 6° each. In some embodiments, the tapered portion has an axial length of 0.075 inches. In some embodiments, the tapered portion has a back clearance angle of about 15° with respect to the rim. In some embodiments, the cutting tooth includes a leading edge; the cylindrical cutter further comprising a rake tooth having a trailing edge; and a gullet formed in the cylindrical wall and defined by the leading edge of the cutting tooth and the trailing edge of the rake tooth; wherein the gullet has a depth of about 0.25 inches measured axially from the rim. In some embodiments, the leading edge and trailing edge are parallel to each other and angled 15° with respect to the axis of rotation.

Other aspects of the invention will become apparent by consideration of the detailed description and accompanying drawings.

### BRIEF DESCRIPTION OF THE DRAWINGS

FIG. 1 is a perspective view of a cylindrical cutter according to one embodiment of the invention.

FIG. 2 is a top view of the cylindrical cutter of FIG. 1.

FIG. 3 is a cross-sectional view taken along line 3-3 in FIG. 2.

FIG. 4 is an enlarged cross-sectional view of one of the cutting teeth of the cylindrical cutter.

FIG. 5 is a perspective view of a blank from which the cutting tool is manufactured.

FIG. 6 is a cross-sectional view of the blank of FIG. 5, taken along line 6-6.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

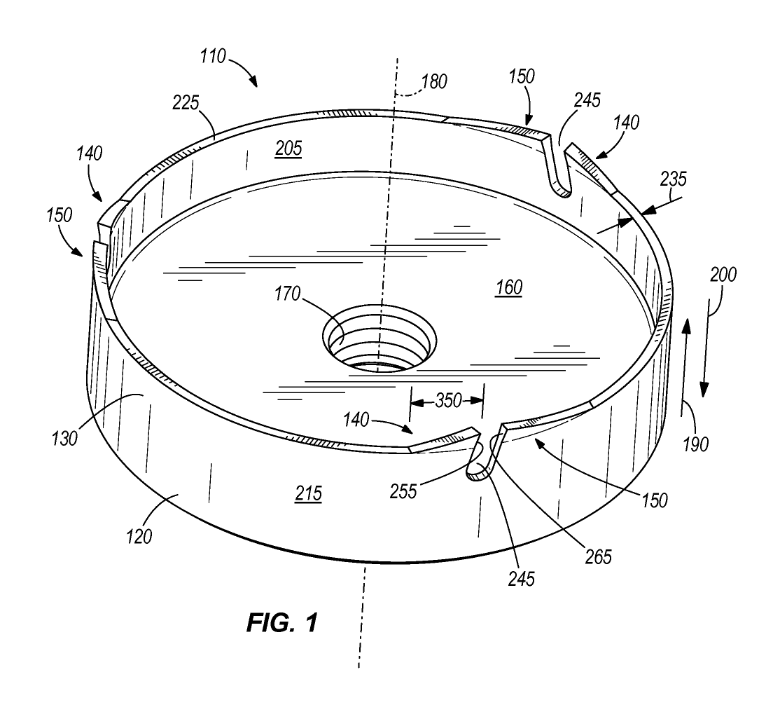

FIGS. 1-3 illustrate a cylindrical cutting tool 110 having a base 120, a generally cylindrical wall 130, a plurality of cutting teeth 140, and a plurality of rake teeth 150. The cutting teeth 140 and rake teeth 150 are in pairs, and in the illustrated embodiment, there are three pairs of cutting teeth 140 and rake teeth 150. The base 120 has the shape of a cylindrical puck, with a base surface 160 that is generally planar, and a central threaded hole 170 to facilitate connection of the cutting tool to a drill or other rotary tool. Under the influence of the rotary tool, the cutting tool is rotated about an axis of rotation 180, which is the same as the axis of symmetry of the base 120 and the central axis of the threaded hole 170, to perform hole-cutting operations.

The cylindrical wall 130 extends in a first direction 190 (parallel to the axis of rotation 180) away from the base 120 on the side of the base surface 160. A second direction 200 is opposite the first direction 190. In this specification, the terms “longitudinal” and “axial” mean in the first direction 190 or the second direction 200, the term “radial” means a direction perpendicular to the axis of rotation 180, and the term “circumferential” means along an arc that is centered on the axis of rotation 180.

The cylindrical wall 130 includes an inner circumferential surface 205 that faces radially toward the axis of rotation 180, and an outer circumferential surface 215 that faces radially away from the axis of rotation 180. The cylindrical wall 130 defines a circumferential rim 225 that exists in a plane parallel to the plane of the base surface 160. In the illustrated embodiment, the cylindrical wall 130 has a height 230 of about 0.305 inches, measured from the base surface 160 to the circumferential rim 225. The cylindrical wall 130 has a constant wall thickness 235, measured between the inner circumferential surface 205 to the outer circumferential surface 215, of about 0.045 inches.

Each cutting tooth 140 is separated from the associated rake tooth 150 by a gullet 245. The gullet 245 is defined between a leading edge 255 of the cutting tooth 140 (i.e., the first portion of the cutting tooth 140 to pass a given point on the work piece in each rotation in a cutting operation) and a trailing edge 265 of the rake tooth 150 (i.e., the last portion of the rake tooth 150 to pass a given point on the work piece in each rotation in a cutting operation). Both of the trailing edge 265 and leading edge 255 are angled circumferentially 15° in the forward direction (i.e., in the direction of tool rotation) with respect the axis of rotation 180, and as such are parallel to each other. The width of the gullet 245 (measured between the leading edge 255 and the trailing edge 265) is 0.124 inches, and the depth of the gullet 245 is 0.25 inches measured axially from the circumferential rim 225. The bottom of the gullet 245 has a radius of curvature of 0.062 inches. The clearance of the tip of the cutting tooth 140 beyond the tip of the rake tooth 150 in the first direction 190 is 0.008-0.010 inches. Stated another, way, the tip of the cutting tooth 140 extends axially 0.008-0.010 inches beyond the tip of the rake tooth 150. A back clearance angle 275 of the cutting tooth 140 with respect to the circumferential rim 225 is 15° in the illustrated embodiment. A rake tooth angle 285 in the illustrated embodiment is 8° with respect to the circumferential rim 225.

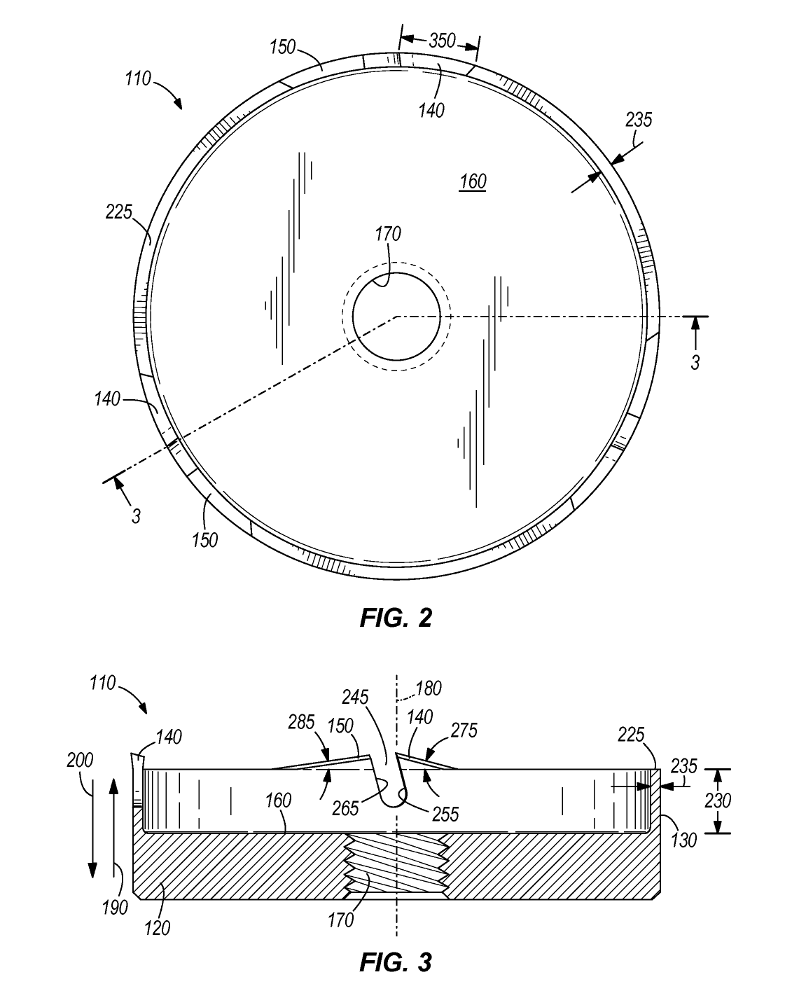

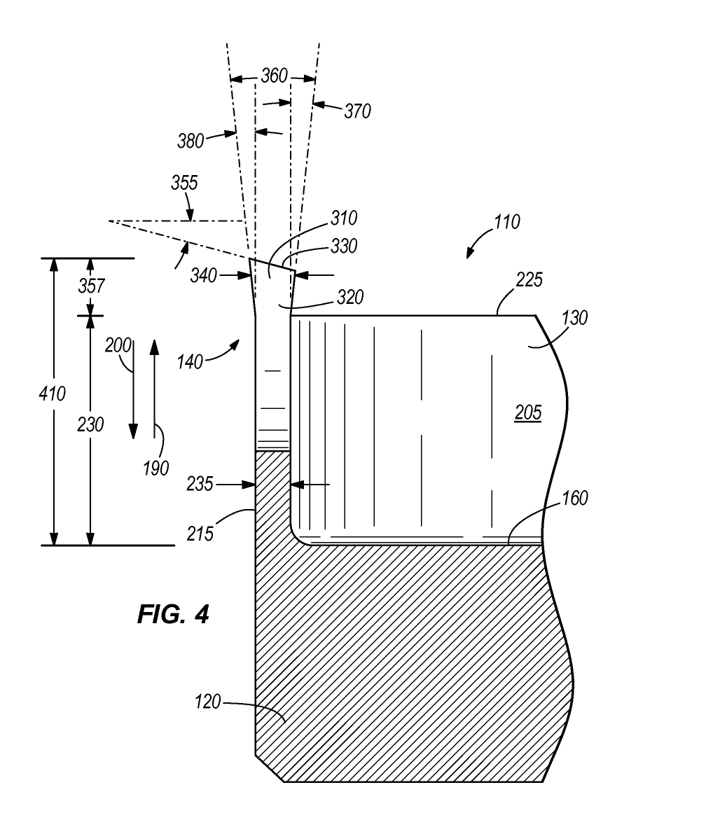

Referring now to FIG. 4, each cutting tooth 140 includes a tapered portion 310 having a root 320 and a free end 330. The tapered portion 310 extends axially, in the first direction 190 away from the circumferential rim 225, and is integrally formed with the cylindrical wall 130 in the illustrated embodiment. The root 320 meets the circumferential rim 225 and has a root thickness equal to the wall thickness 235 of the cylindrical wall 130. The radial thickness 340 of the wall of the tapered portion 310 increases from the root 320 to the free end 330. For clarity, the radial thickness 340 of the wall of the tapered portion 310 is measured in a direction perpendicular to the axis of rotation 180 (the radial thickness 340 is distinguished from the circumferential length 350 or thickness of the tapered wall which is measured circumferentially, as illustrated in FIGS. 1 and 2). As used in this specification, an element is said to “taper” in a direction in which a dimension becomes smaller. The tapered portion 310 may therefore be said to taper in the second direction 200, from the free end 330 to the root 320, because the radial thickness 340 decreases in the second direction 200.

The free end 330 defines a point angle 355, which is about 15° in the illustrated embodiment. This results in the outer circumferential edge of the free end 330 being higher than the inner circumferential edge in the illustrated embodiment. This arrangement reduces burring of the back surface of the material through which the cutting tool 110 cuts because the cutting operation is lead by the outer circumferential edge. The height 357 of the tapered portion 310 is measured from the circumferential rim 225 to the outer circumferential edge. In the illustrated embodiment the tapered portion height 357 is 0.075 inches.

The tapered portion 310 includes extensions of the inner circumferential surface 205 and the outer circumferential surface 215. The overall taper angle 360 of the tapered portion 310 combines an inner taper angle 370 and an outer taper angle 380, which may also be referred to as an inner diameter taper and outer diameter taper, respectively. The inner taper angle 370 is the angle of the inner circumferential surface 205 of the tapered portion 310 with respect to the inner circumferential surface 205 of the cylindrical wall 130, and the outer taper angle 380 is the angle of the outer circumferential surface 215 of the tapered portion 310 with respect to the outer circumferential surface 215 of the cylindrical wall 130. Because the inner circumferential surface 205 and the outer circumferential surface 215 are parallel to the axis of rotation 180 (i.e., vertical), the inner taper angle 370 and outer taper angle 380 can also be expressed as the angle between the inner circumferential surface 205 of the tapered portion 310 and the axis of rotation 180, and the angle between the outer circumferential surface 215 of the tapered portion 310 and the axis of rotation 180, respectively.

In the illustrated embodiment, the inner taper angle 370 is 6.6° and the outer taper angle 380 is 6.6°, such that the overall taper angle 360 is 13.2°. In other embodiments, the overall taper angle 360 is at least 3°. In other embodiments, the overall taper angle 360 is at least 6°. In other embodiments the overall taper angle 360 is at least 12°. The inner taper angle 370 and the outer taper angle 380 may be equal or unequal in other embodiments. In some embodiments, one of the inner taper angle 370 and the outer taper angle 380 is zero. In some embodiments, at least one of the inner taper angle 370 and the outer taper angle 380 is at least 3°. In other embodiments, at least one of the inner taper angle 370 and the outer taper angle 380 is at least 6°.

One advantage of the present invention is that the tapered portion 310 sits atop the cylindrical wall 130, which is not tapered. As a result, the height 357 of the tapered portion 310 can be a relatively small portion of the cup height 410. “Cup height,” as used herein, means the combined cylindrical wall height 230 and tapered portion height 357. In the illustrated embodiment, the cylindrical wall height 230 is 0.305 inches while the tapered portion height 357 is 0.075 inches, resulting in a cup height 410 of 0.380 inches. The ratio of tapered portion height 357 to cup height is therefore 0.197 in the illustrated embodiment. Because the cylindrical wall thickness 235 is constant, the cylindrical wall 130 can be given a height 230 appropriate for the thickness of the piece being cut, without changing any dimensions of the tapered portion 310. As the cylindrical wall height 230 grows, the ratio of tapered portion height 357 to cup height 410 reduces (e.g., at a cylindrical wall height 230 of 0.425 inches, the cup height 410 is 0.500 inches and the ratio drops to 0.15). Because the root 320 of the tapered portion 310 is the same as the thickness 235 of the cylindrical wall 130, the tapered portion 310 does not become weaker as the cylindrical wall height 230 is increased. In the present invention, the ratio of tapered portion height 357 to cup height 410 is no greater than 0.2.

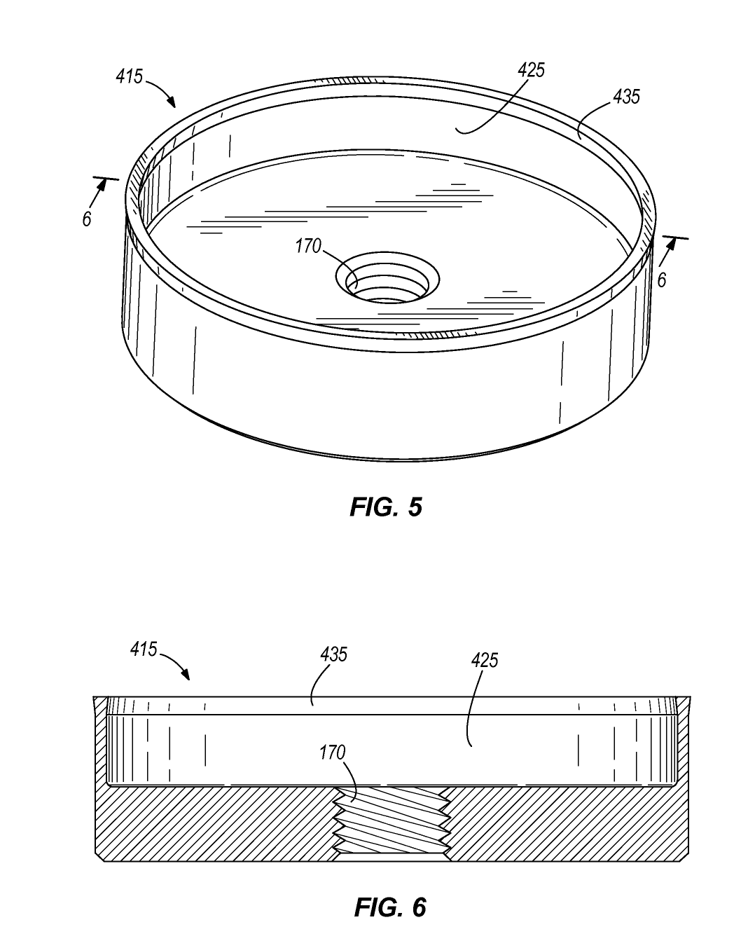

FIGS. 5 and 6 illustrate a blank 415 from which the cutting tool may be machined. The blank 415 is cup-shaped, and includes a cylindrical wall 425 topped by a circumferential tapered portion 435. The cutting tool is machined from this cup-shaped blank 415, such that the cutting teeth 140 and rake teeth 150 are integrally formed with the cylindrical wall 130. The circumferential tapered portion 435 is machined to become the tapered portion 310 of the cutting teeth 140. The gullet 245 and all other features and elements of the cutting tool are formed by removing material from this blank 415.

An example of a known cutting tool is that disclosed in U.S. Pat. No. 5,639,193. One advantage of the present cutting tool over known tools is the relatively severely tapered side walls of the tapered portions of each tooth. Known cutting tools include tapered portions that have an overall taper of 3° or less, with the inner taper angle and outer taper angle each being no larger than 1.5°. The cutting and rake teeth in such known tools are relatively tall, at about 0.61 inches, and have a continuous taper from the tip of the cutting tooth to the base surface (i.e., the teeth taper over the entire cup height, and as a result the ratio of tapered portion height to cup height is 1). Using a severe overall taper angle, inner taper angle, or outer taper angle in a known cutting tool would result in a thin root for the cutting tooth, which may unacceptably compromise the strength of the cutting tooth. Even at a less aggressive overall taper rate of 3°, the cutting teeth and rake teeth would become weak at the root as the cup height is increased, due to the constant taper along the entire cup height.

The present invention permits a severe overall taper angle 360, inner taper angle 370, and outer taper angle 380 because the tapered portion 310 of the cutting tooth 140 is relatively short, which results in a thick root 320 for support of the tapered portion 310. The cylindrical wall 130 in the present invention is thick enough to support the tapered portion 310 during the cutting operation. The severe taper angles of a cutting tool according to the present invention reduce friction and drag around the cutting tip of the cutting tooth 140, as the tooth side walls angle relatively quickly away from the sheet or other work piece into which a hole is being cut. The cup height can be increased for thicker materials to be cut, without compromising the strength of the cutting tooth, due to cylinder wall having a constant thickness and the root of the tapered portion being at the wall thickness.

Thus, the invention provides, among other things, a cutting tool having a cutting tooth 140 with a tapered portion 310, characterized by an overall taper angle 360 in the tapered portion 310 larger than 3°, and having a tapered portion 310 sitting atop a cylindrical wall of constant thickness. Various features and advantages of the invention are set forth in the following claims.

What is claimed is:

1. A cylindrical cutter comprising:
a base having an axis of rotation about which the cutter is rotatable;
a generally cylindrical wall extending from said base surface in a first direction parallel to the axis of rotation, said cylindrical wall having a cylindrical wall thickness, said cylindrical wall defining a rim; and
at least one cutting tooth formed at least partially in the cylindrical wall and having a tapered portion extending in the first direction beyond the rim, the tapered portion including a root and a free end;
wherein the root of the tapered portion is joined to the cylindrical wall at the rim and has a thickness equal to the cylindrical wall thickness;
where the tapered portion has an overall taper angle from the free end to the root of at least 3°.

2. The cylindrical cutter of claim 1, wherein the tapered portion defines an outer surface facing radially away from the axis of rotation and an inner surface facing radially toward the axis of rotation, and wherein at least one of the outer surface and inner surface tapers from the free end to the root at a rate of at least 3°.

3. The cylindrical cutter of claim 1, wherein the tapered portion defines an outer surface facing radially away from the axis of rotation and an inner surface facing radially toward the axis of rotation, and wherein at least one of the outer surface and inner surface tapers from the free end to the root at a rate of at least 6°.

4. The cylindrical cutter of claim 1, wherein the tapered portion defines an outer surface facing radially away from the axis of rotation and an inner surface facing radially toward the axis of rotation, and wherein both the outer surface and the inner surface taper from the free end to the root at a rate of at least 3° each.

5. The cylindrical cutter of claim 1, wherein the tapered portion defines an outer surface facing radially away from the axis of rotation and an inner surface facing radially toward the axis of rotation, and wherein both the outer surface and the inner surface taper from the free end to the root at a rate of at least 6° each.

6. The cylindrical cutter of claim 1, wherein the tapered portion has an axial length of 0.075 inches.

7. The cylindrical cutter of claim 1, wherein the tapered portion has a back clearance angle of about 15° with respect to the rim.

8. The cylindrical cutter of claim 1, wherein the cutting tooth includes a leading edge; the cylindrical cutter further comprising a rake tooth having a trailing edge; and a gullet formed in the cylindrical wall and defined by the leading edge of the cutting tooth and the trailing edge of the rake tooth; wherein the gullet has a depth of about 0.25 inches measured axially from the rim.

9. The cylindrical cutter of claim 8, wherein the leading edge and trailing edge are parallel to each other and angled 15° with respect to the axis of rotation.

10. The cylindrical cutter of claim 1, wherein the cylindrical wall thickness is constant from the base surface to the rim.

11. The cylindrical cutter of claim 1, wherein a cup height of the cutter is the combined heights of the tapered portion and the cylindrical wall; and wherein the ratio of tapered portion height to cup height is no greater than 0.2.
